(19) United States
(12) Patent Application Publication
(10) Pub. No.: US 2024/0316730 A1
(43) Pub. Date: Sep. 26, 2024

(54) MODULAR GRASPING TONGS

(71) Applicant: ANYTONGS LLC, Clifton, NJ (US)

(72) Inventor: Tsogyel Samphel, Clifton, NJ (US)

(73) Assignee: ANYTONGS LLC, Clifton, NJ (US)

(21) Appl. No.: 18/609,090

(22) Filed: Mar. 19, 2024

Related U.S. Application Data
(60) Provisional application No. 63/453,757, filed on Mar. 22, 2023.

(51) Int. Cl. B25B 7/14; A47G 21/06; A47G 21/10; B25B 7/08

(52) U.S. Cl. CPC B25B 7/14; B25B 7/08; A47G 21/06; A47G 21/10

(57) ABSTRACT

A hand-held, modular pair of tongs for grasping and manipulating items or substances is disclosed. The tongs include a first arm and a second arm connected by a hinge, the hinge being biased towards a maximum angle of extension, and the first arm and second arm each terminating in two or more grasping fingers, each grasping finger being biased outward. A grasping finger lock on each arm, when retracted, permits the two or more grasping fingers of its arm to rest outward to release any tip being grasped, and, when extended, forces the two or more grasping fingers of its arm inward to enclose a tip between them. A hinge lock, when retracted while the pair of tongs is closed prevents their opening. A tightening bolt, when rotated, reduces a force necessary to prevent the hinge fully opening, or locks the hinge in a partially open position.

### CROSS-REFERENCE TO RELATED APPLICATION

This non-provisional application claims priority to co-pending provisional application U.S. Pat. App. Ser. No. 63/453,757, filed Mar. 22, 2024 and also titled “Modular Grasping Tongs”, which is hereby incorporated by reference in its entirety.

### FIELD OF INVENTION

This disclosure relates to a hand-held implement to be used as a pair of tongs for grasping and manipulating objects or substances, and more specifically, to a modular tong system for accepting arbitrary and/or interchangeable arms or grasping surfaces with which to grasp and manipulate the objects or substances.

### BACKGROUND

Tongs are a tool that have been used for thousands of years in a variety of contexts, all of which involve replacing the grasping action of a thumb and forefinger with a handheld lever and two grasping surfaces at a greater distance away from the hand. Tongs may be used because a surface is unsafe to touch with the bare hand (for example, barbecue tongs, fireplace tongs, or crucible tongs), when such touch would be unsanitary or socially unacceptable (for example, sugar tongs or salad tongs), or when very fine motor control assistance is needed (for example, jeweler's tongs, tweezers, or forceps).

As the list of above examples shows, tongs are generally specialized to a particular purpose and are generally counterproductive for use in a different context. The material at the end of each tong arm, the geometry or overall shape of teach tong arm, and/or grasping surface at the end of each tong arm is often completely unsuitable for another task. Wooden salad tongs are great for tossing and serving salad, but terrible for manipulating sugar cubes, absorbing meat juices, or burning in contact with flame: sugar tongs or crucible tongs are similarly terrible for manipulating salads. Consumers are forced to purchase completely different sets of tongs for each expected use case.

Moreover, although tongs can provide a force multiplier depending on the position of the fulcrum compared to the grasping tips and the location of the user's finger engagement, they do still require the user to supply a sufficient and steady amount of pressure during use. In elderly or differently-abled users, hand strength may be absent or erratic and cause an item being grasped by tongs to be dropped or crushed by a change in supplied pressure.

Thus, there are advantages to more advanced tongs or tong-like implements that offer flexibility, adaptability to new use cases, and modifications for easier use by individuals with decreased hand strength or other physical disabilities.

### SUMMARY OF THE INVENTION

In order to address the limitations of previous implements, a modular pair of tongs is disclosed. The tongs include a first arm and a second arm connected by a hinge, the hinge having a spring or other force applying mechanism biasing the hinge towards a maximum angle of extension, and the first arm and second arm each terminating in two or more grasping fingers, each grasping finger being biased away from an axis of its arm. A grasping finger lock on each arm, when retracted, permits the two or more grasping fingers of its arm to rest away from the axis of the arm to release any tip being grasped by the grasping fingers, and, when extended, forces the two or more grasping fingers of its arm towards the axis of the arm to enclose a tip between them. A hinge lock, when retracted and when the pair of tongs is closed, ensures that the hinge will not be able to open.

In some embodiments, the tongs also include a tightening bolt that, when rotated, reduces a force necessary to overcome the spring or other force-applying mechanism biasing the hinge towards the maximum angle of extension, or locks the hinge in a partially open position.

### BRIEF DESCRIPTION OF THE DRAWINGS

Other aspects, features and advantages will become more fully apparent from the following detailed description, the appended claims, and the accompanying drawings (provided solely for purposes of illustration without restricting the scope of any embodiment), of which:

FIG. 1 depicts an exploded perspective view of parts that are assembled into a pair of modular tongs:

FIG. 2A depicts a perspective view of the assembled modular tongs from FIG. 1, with the grasping finger locks in an extended distal position:

FIG. 2B depicts a perspective view of the same assembled modular tongs as FIG. 2A, from the other side of the plane in which the tongs open and close:

FIG. 3A depicts a perspective view of the assembled modular tongs from FIG. 1, with the grasping finger locks in a retracted proximal position:

FIG. 3B depicts a perspective view of the same assembled modular tongs as FIG. 3A, from the other side of the plane in which the tongs open and close:

FIG. 4 depicts insertion of possible grasping tips while the grasping finger locks are retracted and the grasping fingers are open:

FIG. 5A depicts a side view of the assembled modular tongs in an open position, with the grasping finger locks extended and the central hinge unlocked:

FIG. 5B depicts a side view of the assembled modular tongs in a closed position, with the grasping finger locks extended and the central hinge locked:

FIG. 6 depicts an alternative embodiment pair of modular tongs with a tightening bolt incorporated into the central hinge:

FIG. 7 depicts a possible embodiment of hinge lock with a stepped outer surface:

FIG. 8 depicts a possible embodiment of hinge lock with an angled facet outer surface:

FIG. 9 depicts a possible embodiment of hinge lock with an inner surface with detents;

FIG. 10 depicts a possible embodiment of hinge lock with a rotating cam operated by a twisting knob; and

FIG. 11 depicts a possible embodiment of hinge lock with a gear operated by a twisting knob.

### DETAILED DESCRIPTION OF THE DRAWINGS

In order to address the limitations of existing tongs, a novel construction for modular tongs is disclosed, allowing for a reusable assembly into which a variety of tips, implements, or other grasping surfaces can be inserted and locked into place. Two pairs of grasping fingers releasably lock an exchangeable tip into position—the tip possibly being a custom designed accessory for use with the tongs, or possibly being an ordinary household item such as a fork or spoon-such that the tongs can be operated with any two terminal grasping surfaces or tools that a user desires. Further, the hinge is designed to allow for locking the tongs closed, locking the tongs in a partially open position, or providing a counterforce so that a user does not need to maintain consistent grip strength to use the tongs.

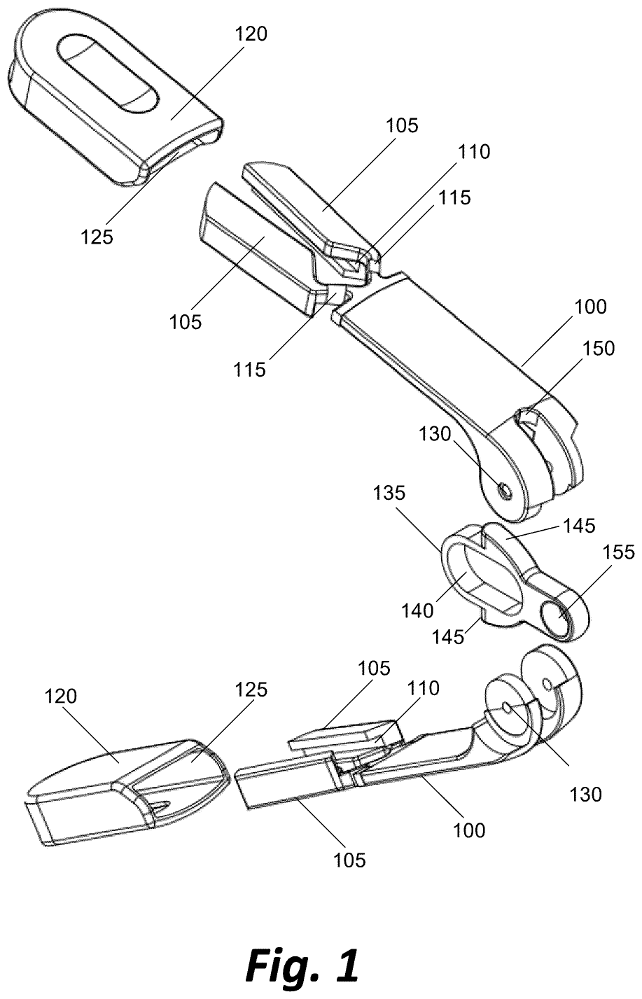

FIG. 1 depicts an exploded perspective view of parts that are assembled into a pair of modular tongs.

Two tong arms 100 are each designed with two or more fingers 105 at a distal end and with a mating surface at the proximal end for forming a central hinge with the mating surface of the other tong arm 100.

As used throughout this disclosure, distal refers to the direction away from the hand and away from the central hinge of the tongs, while proximal refers to the direction towards the hand and away from the tips of the tongs.

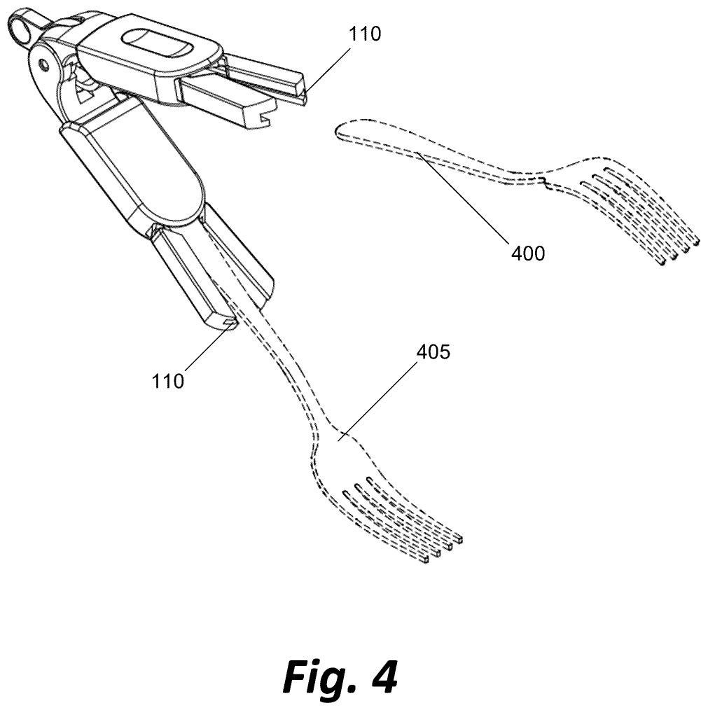

In a preferred embodiment, the fingers 105 each include a channel 110 that passes through the length of the finger 105 and through which a removable/exchangeable grasping surface will pass and be held in place when the fingers 105 are forced together (see FIG. 4). It is conceivable that in some alternative embodiments, the fingers 105 may not have channels 110, and might instead rely on sufficient friction and pressure from a flat surface, or that there might be an asymmetry such that only one of the fingers 105 has a channel 110, and the other has a flat surface or other surface.

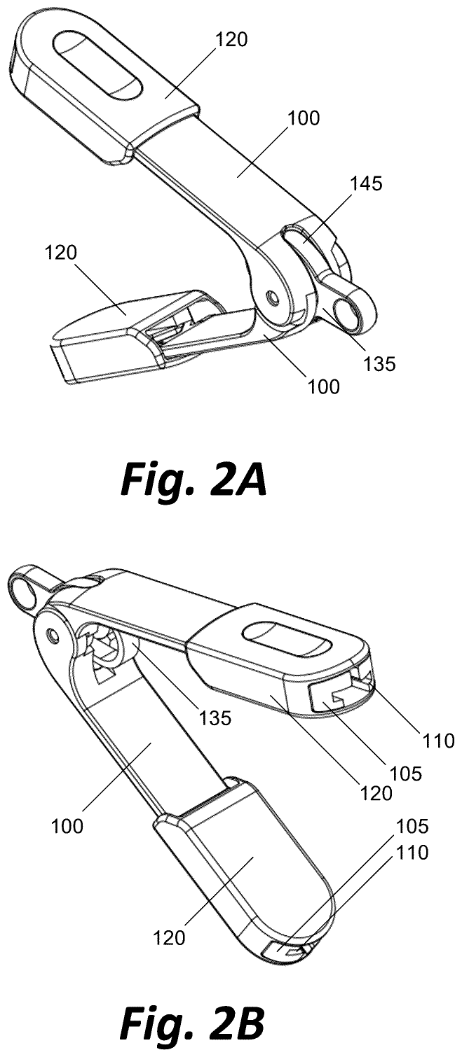

The fingers 105 are connected to each arm 100 by a flexible neck or base 115, preferably made of a softer and more flexible/springy plastic or other material compared to either the fingers or the arms. In a resting state, the fingers 105 project outward laterally from the axis of the arm 100 by a shallow angle. However, when a finger lock 120 passes over the fingers 105, the inner volume 125 of the finger lock 120 is insufficiently large to accommodate the fingers 105 in their resting state, and as a result, they are forced together snugly, or at least to a narrower angle of separation than they had in their resting state (see FIG. 2B).

As depicted here, the arm 100 and fingers 105 have a substantially rectangular cross section, so that the finger lock 120 need only force two fingers 105 inward from their rest states that laterally project outward from the arm 100, in order to firmly grasp an interchangeable tip between the fingers. In alternative embodiments, fingers might be used with a different geometry, such as three or more fingers in a circular arrangement.

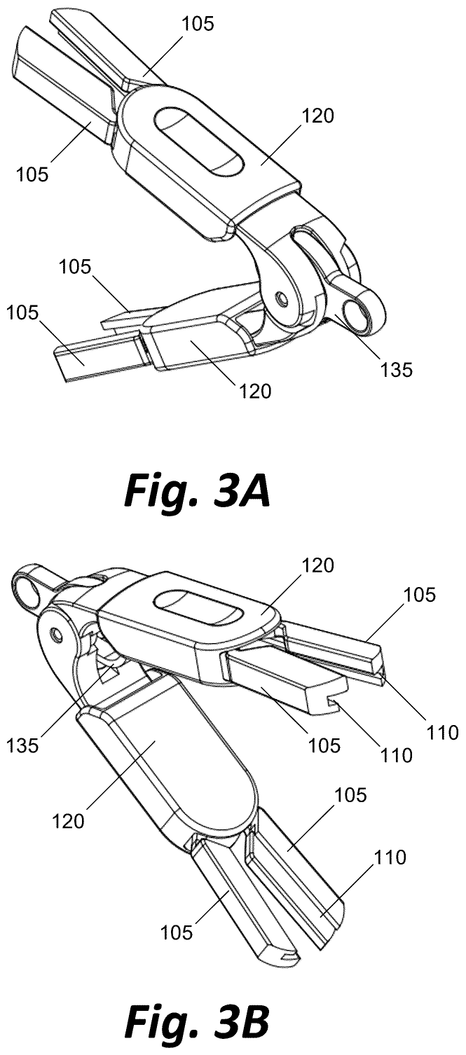

Although the exploded view shows each lock 120 fully extended distally beyond the fingers 105, the lock is retained after assembly such that it can slide freely in the proximal direction along the length of the arm 100 (see FIG. 3A) or distally to the extent of fully enclosing the fingers 105 (see FIG. 2A). However, it is prevented from sliding further distally and being separated from the rest of the tongs.

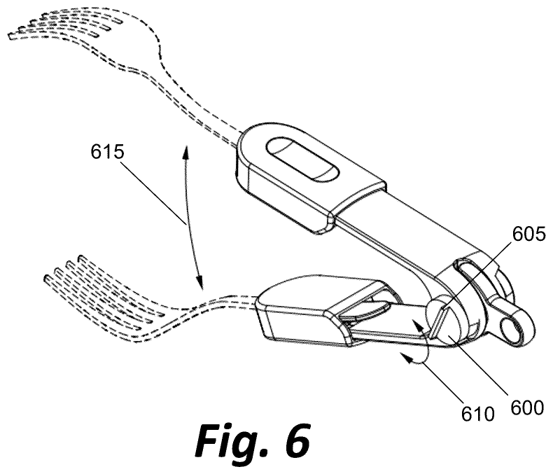

At the proximal end of each arm 100 is a mating surface for its corresponding arm to form the hinge or fulcrum of the tongs. The mating surfaces include a number of guide holes 130 through which, in one embodiment, a pin or rivet may be inserted to permanently affix the arms together. In an alternative embodiment, a more complex element may be included to interact with the guide holes 130 and alter the hinge's behavior (see FIGS. 6 and 9 through 11). A leaf spring, coil spring, elastic band, magnet, shape-alloy, lever, or other force-supplying element (not pictured) is incorporated into the hinge and connected to each arm 100, such that the arms are biased outward in their resting position, and pressure must be continuously applied to maintain the arms in a more closed position compared to the resting position-except, again, when the hinge behavior is altered (see discussion of FIGS. 6 through 11, below).

A ring-shaped hinge lock 135 is preferably incorporated into the hinge and capable of sliding proximally and distally thanks to an elliptical (or otherwise extended) inner volume 140 that can surround any internal mechanisms or elements of the hinge in its most proximal position, and yet the hinge lock 135 can slide distally without interfering with any of the elements passing through the inner volume 140. The hinge lock 135 includes one or more tabs or other outer surfaces 145 that are capable of engaging with a corresponding surface 150 when the hinge lock is in a distally extended position.

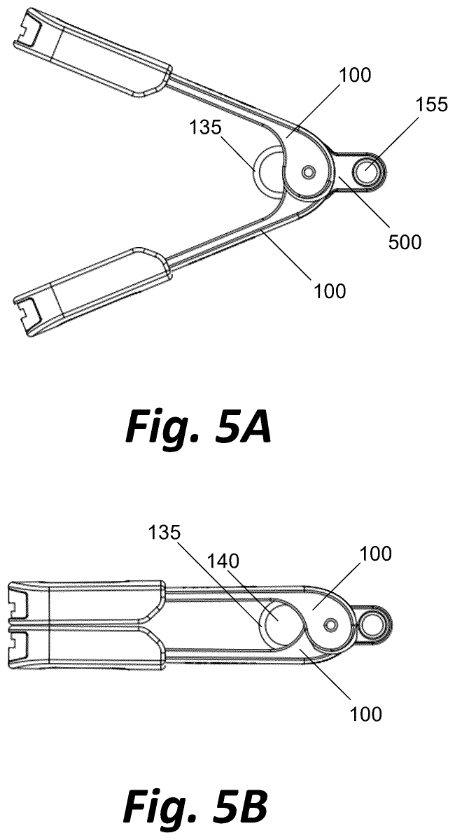

When the hinge lock 135 is in a relatively proximal position, the tongs are permitted to open (see FIG. 5A), but when it is extended distally, the tongs are locked in a fully closed position (see FIG. 5B), and the hinge lock 135 persistently overcomes any biasing force provided by the spring or elastic. The locking may be accomplished by the tabs or other outer surfaces 145 occupying a space that a solid protrusion of the arm's inner surface 150 would need to occupy for the arm 100 to move into an open position, and thus the rigidity of the arm and of that solid protrusion firmly locks the arms together. As depicted, the hinge lock 135 and its outer surfaces 145 are symmetric and independent of either arm; in alternative embodiments, it may be imagined that the hinge lock is fully incorporated into one arm and only requires a single outer surface 145 for engagement with the other arm.

Finally, the hinge lock 135 may also incorporate a ring 155 to aid in grasping the hinge lock and sliding it proximally or distally, or for hanging the tongs on a wall peg or keychain when not in use.

In a preferred embodiment, all of the elements of the tongs are formed from a rigid thermoplastic except where otherwise noted (for example, with the flexible finger bases 115 or the spring or other biasing force supplying element). In other embodiments, other materials, such as other plastics, metal, wood, ceramic, or any other rigid material may be used instead to form some or all of these elements.

As depicted, the outer surfaces of the arms 100 are smooth, while the surfaces of the finger locks 120 have some texturing to make them easier to slide with the finger and thumb. In various embodiments, different texturing or finishes may be applied to the arms and finger locks to make them easier to grasp and apply pressure without the tongs slipping in the hand.

FIG. 2A depicts a perspective view of the assembled modular tongs from FIG. 1, with the grasping finger locks in an extended distal position.

As depicted, the assembled tongs are in roughly the same perspective angle and position as in the previous figure. With the finger locks 120 in the fully extended position, the fingers 105 are completely enclosed and—from this perspective-completely hidden.

FIG. 2B depicts a perspective view of the same assembled modular tongs as FIG. 2A, from the other side of the plane in which the tongs open and close.

From this opposite view, it can be seen how each finger lock 120 forces the pairs of fingers 105 into a touching or almost-touching position. The channels 110 form a much smaller volume with a substantially rectangular cross section that may correspond to a number of common implements, such as flatware/cutlery (see FIG. 4) that can be grasped tightly inside the volume when the finger lock 120 tightens the fingers and channels together.

FIG. 3A depicts a perspective view of the assembled modular tongs from FIG. 1, with the grasping finger locks in a retracted proximal position.

As depicted, the tongs are in an identical perspective angle and position to the previous figure, and a similar angle to FIG. 1. Now, with the finger locks 120 fully retracted along the arms in the proximal direction, the resting position of the fingers 105, in a comparatively open configuration, can be seen.

FIG. 3B depicts a perspective view of the same assembled modular tongs as FIG. 3A, from the other side of the plane in which the tongs open and close.

From this opposite view, it can be even more clearly seen how each finger lock 120 no longer interferes with the positioning of the pairs of fingers 105. The channels 110 no longer form a smaller volume and would release any interchangeable tip that had been previously grasped, once the finger lock has been slid back.

FIG. 4 depicts insertion of possible grasping tips while the grasping finger locks are retracted and the grasping fingers are open.

This perspective drawing recreates FIG. 3B, with the change that a pair of exchangeable tips 400, 405 are depicted. The first tip 400 is aligned for entry with the upper channels 110, while the second tip 405 is already enclosed within the space that will be constricted once the finger locks 120 are extended. Although ordinary forks are depicted for the first tip 400 and second tip 405, any combination of tips may be chosen, so long as their cross-sections permit grasping by the channels 110 of the fingers 105. A fork and a spoon may be selected for salad tongs: two spoons may be used for manipulating pills, marbles, pearls, or other substantially round objects: two chisels or other fine tips may be used for manipulation and grasping of fine or miniscule objects. FIG. 6 depicts, from another angle, the tongs in a grasping mode with the finger locks extended.

FIG. 5A depicts a side view of the assembled modular tongs in an open position, with the grasping finger locks extended and the central hinge unlocked, and FIG. 5B depicts a side view of the assembled modular tongs in a closed position, with the grasping finger locks extended and the central hinge locked.

When the hinge lock 135 is in a relatively proximate position, such that a portion 500 of the hinge lock is visible between the arms 100 and the ring 155 (see FIG. 5A), the outer surfaces 145 of the hinge lock do not engage with the arms, and permit the arms to fully extend to a maximum angle depicted, limited only by the geometry of the mating surfaces of the arms to one another and/or resistance provided by the spring or other force-supplying element.

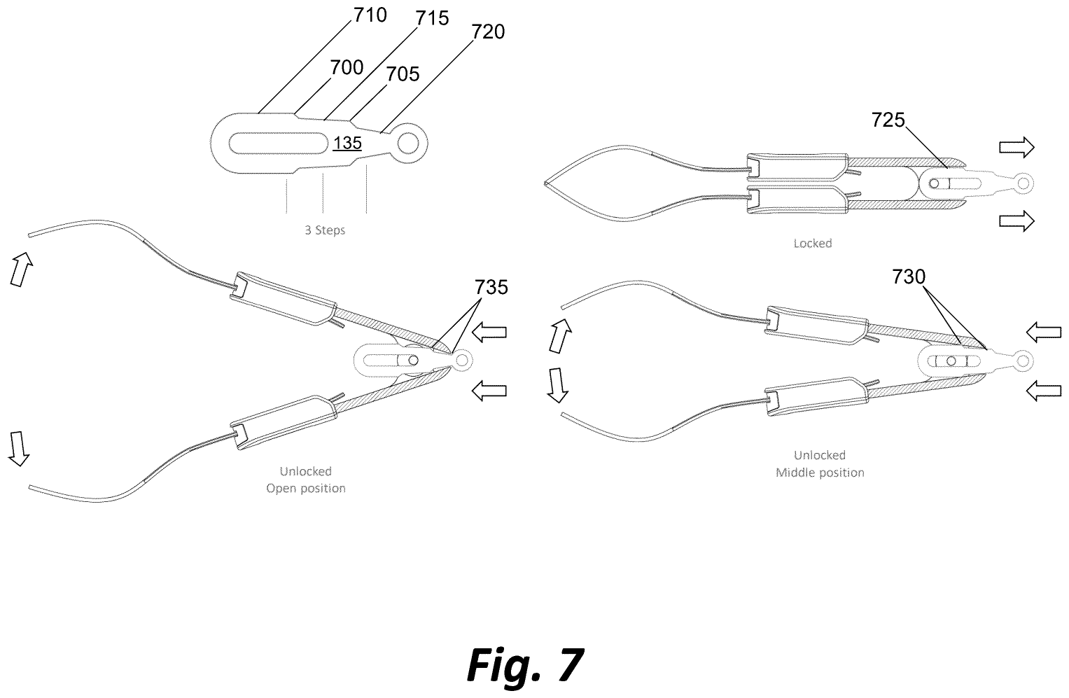

However, when the hinge lock 135 is in a fully distal position, such that no portion 500 is visible between the arms 100 and the ring 155, and such that a greater portion of the hinge lock's inner volume 140 is visible between the arms 100 (see FIG. 5B), the arms 100 are prevented from opening at all. This is accomplished by the outer surfaces 145 of the hinge lock engaging with the inner surfaces 150 of the arms. Five particular embodiments by which the outer surfaces 145 of the hinge lock could engage with the arms and prevent the arms from opening are discussed further below (see FIGS. 7 through 11).

The tongs will remain in a locked state until the hinge lock 135 is pulled in the proximal direction. The locked state may be useful for compact storage, or may potentially be engaged when an item is tightly grasped within the tongs and the user wants to ensure that the item cannot be dropped.

In the latter use case, for preventing unexpected releases, an alternative to relying on the hinge lock 135 may be provided, as depicted in FIG. 6.

FIG. 6 depicts an alternative embodiment pair of modular tongs with a tightening bolt incorporated into the central hinge.

Incorporation of a knob or other control mechanism attached to a bolt or screw 600 into the hinge may permit the action of the hinge to be hampered (by applying additional friction of the bolt 600 against both arms as the spring attempts to separate them) or locked entirely (if the bolt is screwed in sufficiently tight). A ridge 605 on the head of the bolt 600 may be provided to make the bolt easier to rotate clockwise or counterclockwise (610) to tighten or loosen the bolt.

As depicted in FIG. 6, the bolt 600 has been screwed in tightly after a moment at which an angle 615 between the arms was less than the normal resting angle of extension between the tong arms (compare FIG. 6 with FIGS. 2A and 3A). After screwing in the bolt at the preferred angle, with an item grasped between the tips of the tongs, the tongs may be used to move the item without fear that a momentary loss of grip strength will result in the tongs opening and releasing the item. These tongs may thus be used by any individual who fears that, due to the user's physical limitations, conventional tongs present too great a risk of dropping a grasped item before the user is ready to release it.

A less than total locking, via only partial tightening of the bolt 600, may result in applying sufficient friction within the hinge that, during a momentary loss of grip strength, the biasing force provided by the spring or other element does not completely overcome the weakened grip, and a release does not accidentally occur.

In addition to or instead of the bolt 600, or as embodiments of or alternatives to the outer engagement surfaces 145, a number of hinge lock designs are disclosed herein.

FIG. 7 depicts a possible embodiment of hinge lock with a stepped outer surface.

Two protruding corners 700, 705 separate three flat surfaces (a proximal surface 700, a middle surface 705, and a distal surface 710) on both the upper and lower surfaces of the hinge lock 135.

When the hinge lock 135 is fully extended in proximal direction, the widest portion of the lock, between the distal surfaces 710, engage with the arms 100 along a surface 725, completely preventing rotation about the hinge to open. The tongs are thus kept in a releasably locked position.

When the hinge lock 135 is moved a bit more in the distal direction, the arms are permitted to pivot about the first corners 700 until they contact the middle surfaces 715, at stop points 730. The tongs are permitted to reach a diminished maximum angle under the biasing force of the spring or other element in the hinge. If the hinge lock 135 is fully extended in the distal direction, the arms come to contact the second corners 705 and proximal surfaces 720, at stop points 735. The tongs are permitted to reach a greater maximum angle compared to the previous unlocked position.

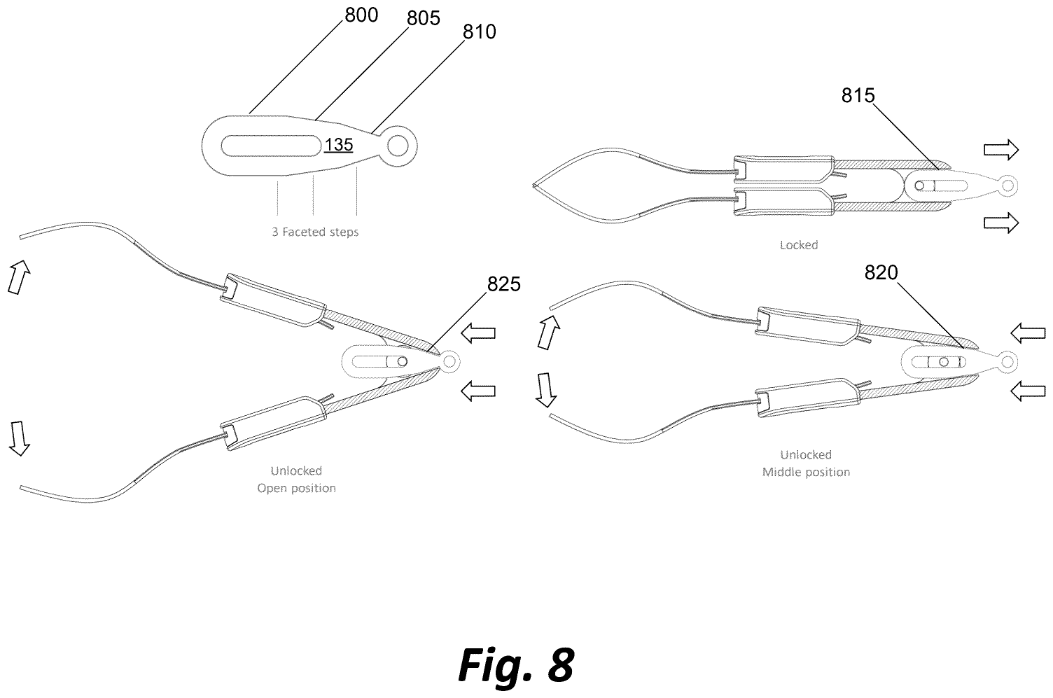

FIG. 8 depicts a possible embodiment of hinge lock with an angled facet outer surface.

In contrast to the design depicted in FIG. 7, FIG. 8 depicts a fully convex design where the distal, middle, and proximal flat surfaces 800, 805, 810 meet smoothly. Like FIG. 7, when the hinge lock is extended fully proximally, the arms 100 rest against distal surfaces 800 and are locked from any movement. In a variant of FIG. 7, rather than two points of engagement between arms and hinge lock when partially unlocked and fully unlocked, the middle surfaces 805 engage the arms 100 along a surface 820, and the proximal surfaces engage the arms 100 along a surface 825. The engagement surfaces 820, 825 may provide greater stability or less wear and tear on the hinge lock 135 over time compared to the particular points of engagement 730, 735.

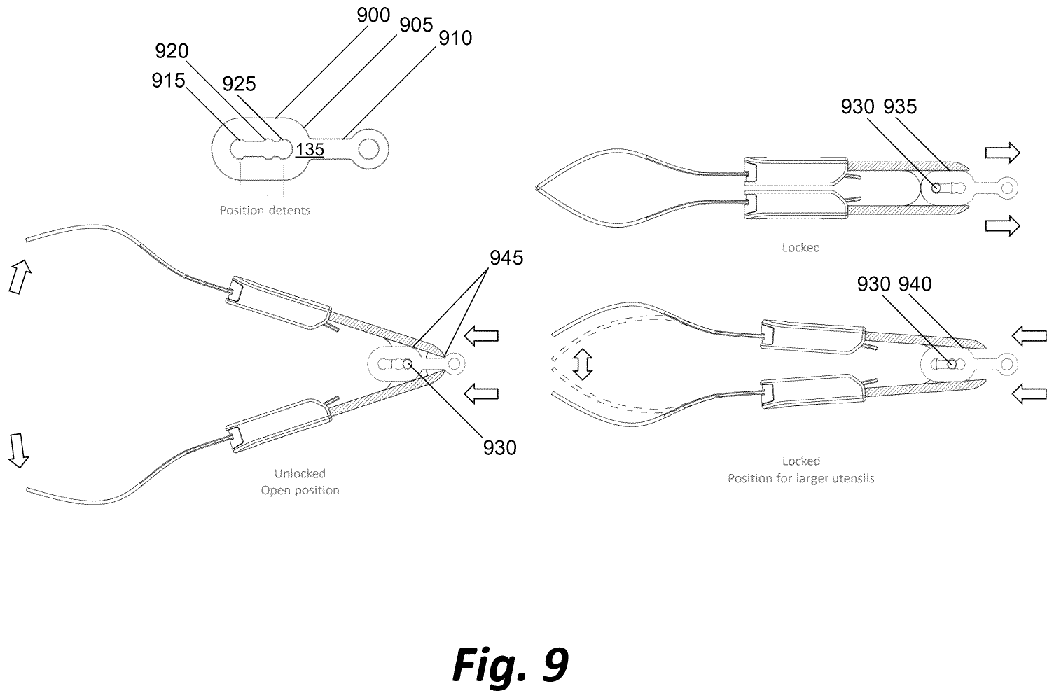

FIG. 9 depicts a possible embodiment of hinge lock with an inner surface with detents.

This hinge lock 135 comprises a distal flat surface 900, a middle curve 905, and a proximal flat surface 910. Additionally, the inner volume 140 has a number of position detents 915, 920, 925 cut into its cross section, to provide natural engagement points for a hinge pin 930. Like FIGS. 7 and 8, when the hinge lock is extended fully proximally, the arms 100 rest against distal flat surfaces 900 along a surface 935 and are locked from any movement. The hinge pin 930 rests in the distal detent 915, preventing incidental movement from as easily moving the lock distally to unlock, compared to other embodiments. When the user pushes the hinge lock distally and slides the distal detent past the pin and the middle detent 920 in its place, the arms 100 are permitted to pivot about the middle curve 905, remaining in contact at a point 940 that is determined based on the shape of the curve 905 and the positioning of the middle detent 920, and which determines the maximum angle to which the tongs may open when partially unlocked. If the hinge lock is extended fully in the distal direction, the pin 930 enters the proximal detent 925 so that the hinge is fully unlocked and will not as easily be inadvertently re-locked. The maximum angle is constrained only by the arms 100 engaging with the proximal flat surface 910 as they continue to rotate about the middle curve 905, meeting the two surfaces at stop points 945.

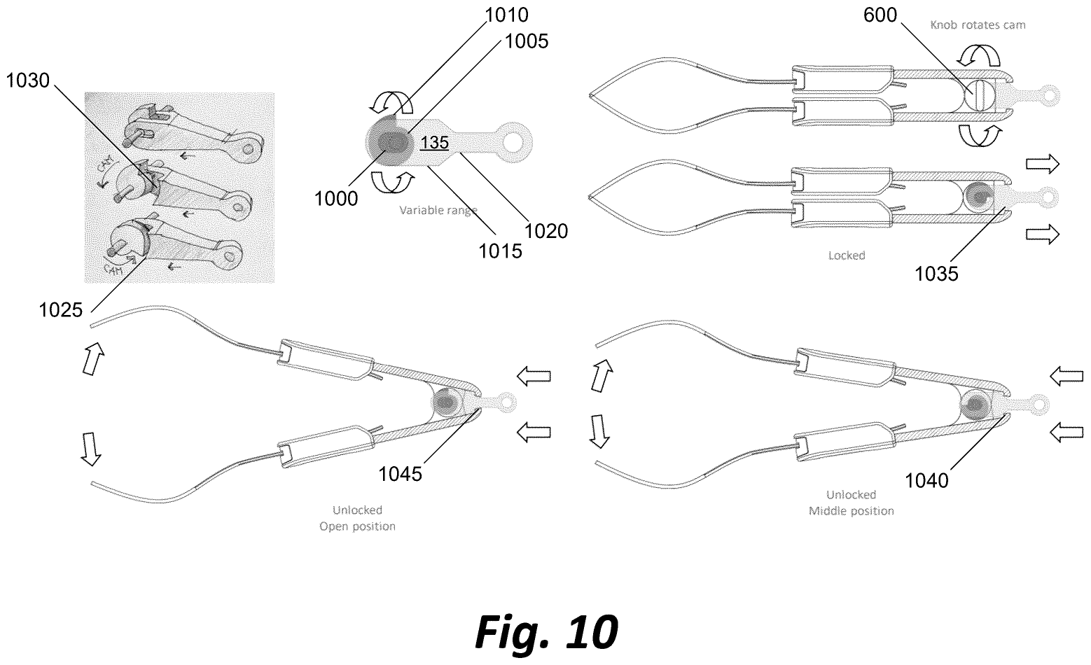

FIG. 10 depicts a possible embodiment of hinge lock with a rotating cam operated by a twisting knob.

Unlike in the embodiments depicted in FIGS. 7-9, the previously mentioned knob or bolt 600 may be attached to a cam 1000 that smoothly transitions, with a spiral cross-section, from a minimum radius 1005 to a maximum radius 1010. The knob 600 is independent of the hinge lock 135, so that the rotation of the knob 600 and the cam 1000 is capable of either preventing distal movement-when the cam's maximum radius engages the hinge lock in a first position 1025—or permitting distal movement-when the cam's maximum radius does not engage the hinge lock as in example position 1030.

As with other hinge lock embodiments, the hinge lock may include a distal flat surface 1015 and a proximal flat surface 1020, with a middle curve or surface between them. Once the knob is rotated to disengage the cam from the hinge lock, the hinge lock moves distally from a locked position (the arms 100 engaging the distal flat surface 1015 at a stop point 1035) to a proximal, unlocked position. The more the cam rotates, the further distal movement is possible, and the stop points slide proximally along the hinge lock from a first partially unlocked position 1040 to a fully unlocked position 1045, where the arms 100 only engage the proximal flat surface 1020.

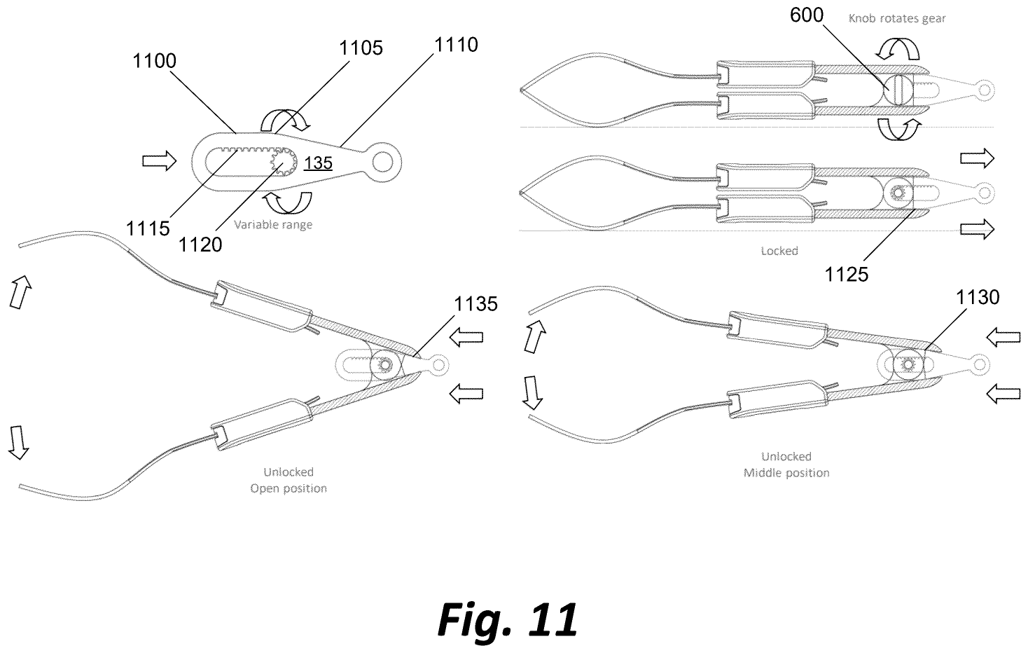

FIG. 11 depicts a possible embodiment of hinge lock with a gear operated by a twisting knob.

In another embodiment, the cam is replaced with a rack and pinion system in the inner volume 140 of the hinge lock 135. The external surfaces of the hinge lock include, similar to other embodiments, a distal flat surface 1100, a corner 1105, and a proximal surface 1110. In the inner volume are a rack 1115 and a pinion or gear 1120 to which the knob 600 is attached. As with other embodiments, when the hinge lock 135 is fully extended proximally, the arms 100 engage the distal flat surfaces 1100 along a stopping surface 1125 and prevent rotation of the arms. The hinge lock is not directly manipulated or moved by a user, as the teeth of the rack 1115 prevent the hinge lock from being pushed past the pinion 1120 distally. Instead, unlocking is accomplished by turning the knob 600 to rotate the pinion 1120, pushing the rack in the distal direction and moving the hinge lock with it.

As the hinge lock moves distally, the arms are permitted to pivot about the corners 1105, which they engage to form a stopping point 1130. When the hinge lock is fully extended distally, and fully unlocks the tongs, the arms 100 rest against the proximal surfaces 1110 to form a stopping surface 1135.

As can be easily seen from the variants described above, the outer surfaces 145 of the hinge lock 135 may include a variety of straight, curved, concave, convex, pointed, or other shapes to act as pivot points or stops for the arms 100. Particular sequences of such shapes are depicted in FIGS. 7-11, but other sequences would permit different locking, maximum angle, and/or minimum angle behaviors.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A modular pair of tongs, comprising:
a first arm and a second arm connected by a hinge, the hinge having a spring or other force applying mechanism biasing the hinge towards a maximum angle of extension, and the first arm and second arm each terminating in two or more grasping fingers, each grasping finger being biased away from an axis of that arm;
a grasping finger lock on each arm, which, when retracted, permits the two or more grasping fingers of that arm to rest away from the axis of that arm and to release any tip being grasped by the grasping fingers, and, when extended, forces the two or more grasping fingers of that arm towards the axis of that arm to enclose a tip between them; and
a hinge lock, such that if the pair of tongs is closed and the hinge lock is retracted, the hinge will not be able to open.

2. The modular pair of tongs of claim 1, further comprising a tightening bolt, wherein the tightening bolt, when rotated, reduces a force necessary to overcome the spring or other force-applying mechanism biasing the hinge towards the maximum angle of extension.

3. The modular pair of tongs of claim 2, wherein the tightening bolt locks the hinge in a partially open position having an angle less than the maximum angle of extension.
